(19) United States
(12) Patent Application Publication
(10) Pub. No.: US 2015/0059941 A1
(43) Pub. Date: Mar. 5, 2015

(54) Pneumatic Tire

(71) Applicant: The Yokohama Rubber Co., LTD., Tokyo (JP)

(72) Inventor: Masakazu Niwa, Hiratsuka-shi (JP)

(73) Assignee: The Yokohama Rubber Co., LTD., Tokyo (JP)

(21) Appl. No.: 14/477,688

(22) Filed: Sep. 4, 2014

(30) Foreign Application Priority Data
Sep. 4, 2013 (JP) 2013-183321

(51) Int. Cl. B60C 11/00; B60C 11/03; B60C 9/00

(52) U.S. Cl. CPC B60C 11/0083; B60C 9/0007; B60C 9/0042; B60C 11/033; B60C 2011/0353
USPC 152/209.14

(57) ABSTRACT

A pneumatic tire having a carcass layer mounted between a pair of bead portions includes belts layers disposed on an outer circumferential side of the carcass layer at a tread portion, with at least one circumferential groove is disposed in the tread portion so as to continue in the tire circumferential direction in a region on one side of the tire center line. A distance La from the tire center line to a center position of the outermost circumferential groove has a relationship of 0.50×L≦La≦0.80×L with respect to a tread half-width L from the tire center line to the outer edge position of the tread portion.

### PRIORITY CLAIM

Priority is claimed to Japan Patent Application Serial No. 2013-183321 filed on Sep. 4, 2013.

### TECHNICAL FIELD

The present technology relates to a pneumatic tire ideally used as a tire for traveling on unpaved roads, and more specifically to a pneumatic tire with excellent road holding performance on a road surface, and enables an enhancement in uneven wear resistance and an improvement in steering stability.

### BACKGROUND

A pneumatic tire for traveling on unpaved roads generally employs wide circumferential grooves in the tread portion in order to improve performance for discharging mud and sand from the grooves, that is, in order to prevent clogging of the grooves. A pneumatic tire for traveling on unpaved roads tends to be easily subject to damage in the side wall portions, and therefore a protective layer including a plurality of organic fiber cords is embedded in the side wall portions along the carcass layer, for example, to prevent side wall cuts due to contact with rocks or sharp stones and to prevent punctures caused by the side wall cuts (see, for example, Japanese Unexamined Patent Application Publication No. H7-290911).

However, the tread portion in the aforementioned pneumatic tire tends to bend easily due to the wide circumferential grooves disposed in the tread portion acting as flex points, and furthermore, the expansion in the tire radial direction of the tread shoulder portions tends to be suppressed when inflating the tire since the stiffness of the side walls is increased due to the addition of the protective layer. As a result, there is a problem that the tread center portion tends to show preferential wear since the ground contact pressure of the tread shoulder is relatively low and steering stability is reduced since side-slipping tends to occur more easily on muddy or sandy terrain.

### SUMMARY

The present technology provides a pneumatic tire that enables excellent road holding performance on a road surface, enhanced uneven wear resistance, and improved steering stability.

The pneumatic tire of the present technology is provided with a tread portion extending in the tire circumferential direction to form an annular shape, a pair of side wall portions that is disposed on both sides of the tread portion, and a pair of bead portions that is disposed on an inner side in the tire radial direction of the side wall portions, and at least one carcass layer is mounted between the pair of bead portions, a plurality of belt layers is disposed on the outer circumferential sides of the carcass layer at the tread portion, and at least one circumferential groove is disposed in the tread portion so as to continue in the tire circumferential direction in a region on one side of the tire center line, wherein

when, in a tire meridian cross-section, P1 is an intersection between the road contact surface of the tread portion and the tire center line; P2 is an intersection between an inner wall surface of an outermost circumferential groove in the tire axial direction and the road contact surface of the tread portion; P3 is an intersection between an outer wall surface of the outermost circumferential groove and the road contact surface of the tread portion; P4 is an outer edge position of the tread portion; L0 is a reference straight line that extends in the tire radial direction from the intersection P1; L1 is a straight line that passes through the intersection P1 and the intersection P2; and L2 is a straight line that passes through the intersection P1 and the outer edge position P4 of the tread portion,

a distance La from the tire center line to a center position of the outermost circumferential groove has the relationship of 0.50×L≦La≦0.80×L with respect to a tread half-width L from the tire center line to the outer edge position P4 of the tread portion,

an angle β formed by the straight line L2 and the reference straight line L0 has a relationship of 1.2×α≦β≦3.5×α with respect to an angle α formed by the straight line L1 and the reference straight line L0, and the intersection P3 is disposed on the outer side in the tire radial direction of the intersection P2 so that a distance H in the tire radial direction between the intersection P2 and the intersection P3 has a relationship of 0 mm<H≦3 mm.

In the pneumatic tire having at least one circumferential groove disposed so as to continue in the tire circumferential direction in a region on one side of the tread portion of the present technology, the distance La from the tire center line to the center position in the outermost circumferential groove has the relationship of 0.50×L≦La≦08.0×L with respect to the tread half-width L, the angles α and β that define the amount of depression of the tread portion have the relationship of 1.2×α≦β≦3.5×α, and the distance H that defines a relative amount of protrusion between land portions positioned on both sides of the outermost circumferential groove is 0 mm<H≦3 mm, whereby uneven wear (early wear) of the tread center portion can be avoided since road holding performance of the land portions positioned at the tread shoulder portions is enhanced and the load on the tread center portion is reduced. Moreover, side-slipping on muddy or sandy terrain is prevented and steering stability can be improved due to the enhancement in the road holding performance of the land portions positioned at the tread shoulder portions.

As a result, even when a wide circumferential groove is provided in the tread portion and the stiffness of the side walls is increased as in a pneumatic tire for traveling on unpaved roads, road holding performance with the road surface is excellent, uneven wear resistance is enhanced, and steering stability can be improved.

A groove width GW of the circumferential groove disposed in the tread portion in the present technology is preferably set to be within a range of 8 mm to 20 mm. By forming a wide circumferential groove in this way, the discharge of mud and sands from the circumferential groove can be improved while the enhancement effects of uneven wear resistance and steering stability can be achieved.

Moreover, a curvature radius Rb of an arc that defines a contour of a region Wb on the outer side of the intersection P3 of the tread portion is preferably 0.05×Ra≦Rb≦0.3×Ra with respect to a curvature radius Ra of an arc that defines a contour of a region Wa from the intersection P1 to the intersection P2 of the tread portion. As a result, the tread portion forms a desirable footprint and uneven wear resistance is further improved.

While the use of the pneumatic tire of the present technology is not limited, the pneumatic tire of the present technology is ideal as a tire for traveling on unpaved roads. The groove area ratio of the tread portion is preferably from 25% to 55% when used as a tire for traveling on unpaved roads.

Furthermore, protective layers that include organic fiber cords are preferably disposed on the outer side of the carcass layer in the side wall portion. As a result, cut resistance can be improved on the basis of the protective layers. As a result, superior cut resistance is demonstrated while an enhancement effect for uneven wear resistance and steering stability can be achieved for a tire for traveling on unpaved roads.

The dimensions for the present technology are measured when the tire is assembled on a regular rim and the inner pressure is set to 50 kPa. That is, the dimensions are measurement values when the tire is made to approximate the mold dimensions.

Moreover, the groove area ratio of the present technology is a ratio of the surface area of the grooves inside the ground contact region versus the surface area of the ground contact region of the tread portion. The ground contact region of the tread portion is specified on the basis of the footprint width in the tire axial direction measured when placed upright on a flat surface with the tire being assembled on a regular rim, inflated to the regular inner pressure, and regular load is applied. “Regular rim” is a rim defined by a standard for each tire according to a standards body that includes standards on which tires are based, for example, JATMA (Japan Automobile Tire Manufacturers Association) is for a standard rim, TRA (Tire and Rim Association) is for a “design rim”, and ETRTO (European Tyre and Rim Technical Organisation) is for a “measuring rim”. “Regular inner pressure” is an air pressure defined by standards for each tire according to a standards body that includes standards on which tires are based. For example, JATMA is for maximum air pressure, TRA is a list of maximum values in the table of “Tire Road Limits At Various Cold Inflation Pressures”, and ETRTO is for inflation pressure and is 180 kPa for a tire on a passenger vehicle. “Regular load” is a load defined by standards for each tire according to a standards body that includes standards on which tires are based, for example, JATMA is for maximum load capacity, TRA is a list of maximum values in the table of “Tire Road Limits At Various Cold Inflation Pressures”, and ETRTO is for load capacity and is a load that corresponds to 88% of the load for a tire on a passenger vehicle.

### BRIEF DESCRIPTION OF THE DRAWINGS

FIG. 1 is a meridian cross-sectional view illustrating a pneumatic tire according to an embodiment of the present technology.

FIG. 2 is a development view illustrating a tread pattern of the pneumatic tire illustrated in FIG. 1.

FIG. 3 is a cross-sectional view illustrating a contour of the tread portion of the pneumatic tire illustrated in FIG. 1.

FIG. 4 is a plan view illustrating a footprint of the pneumatic tire according to an embodiment of the present technology.

FIG. 5 is a plan view illustrating a footprint of a pneumatic tire having a conventional tread structure.

### DETAILED DESCRIPTION

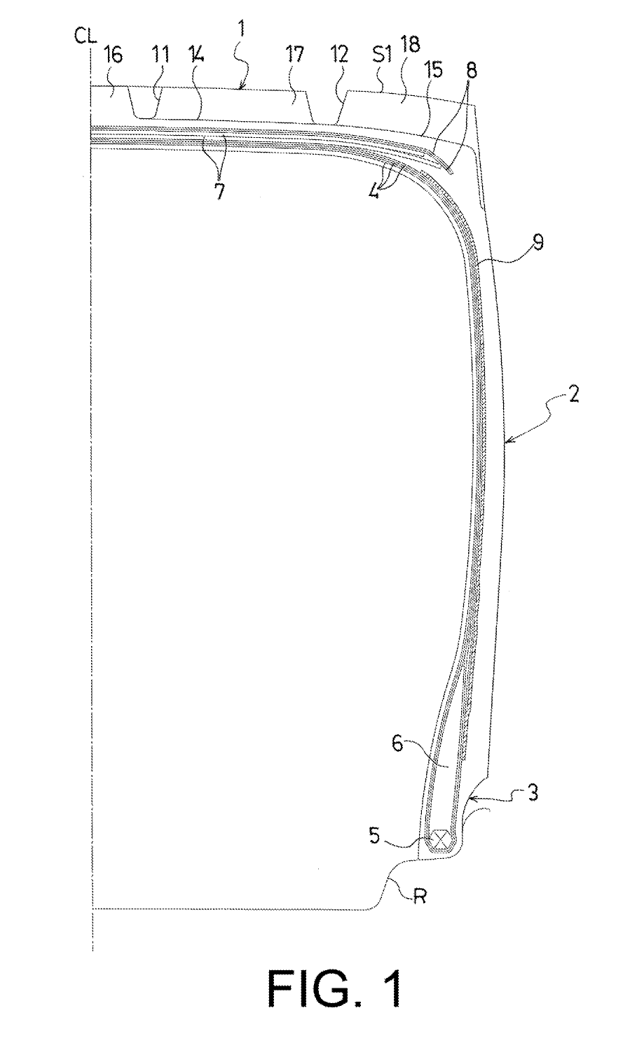

Detailed descriptions will be given below of a configuration of the present technology with reference to the accompanying drawings. FIG. 1 illustrates a pneumatic tire according to an embodiment of the present technology. In FIG. 1, the pneumatic tire according to the embodiment is depicted as the portion on one side bounded by the tire center line CL. However, the pneumatic tire has a symmetrical structure on both sides of the tire center line CL. Also, R is the rim of a wheel on which the pneumatic tire is assembled.

As illustrated in FIG. 1, a pneumatic tire of the embodiment is provided with a tread portion 1 extending in the tire circumferential direction to form an annular shape, a pair of side wall portions 2 that is disposed on both sides of the tread portion 1, and a pair of bead portions 3 that is disposed on the inner side in the tire radial direction of the side wall portions 2.

Three layers of a carcass layer 4 are mounted between the pair of bead portions 3, 3. The carcass layer 4 includes a plurality of reinforcing cords that incline with respect to the tire radial direction and the carcass layer 4 is disposed so that the reinforcing cords intersect each other between the layers. An inclination angle of the reinforcing cords in the carcass layer 4 with respect to the tire circumferential direction is set to be within a range from, for example, 4° to 30° at the maximum tire width position. By using such a half-radial structure, the desired stiffness can be assured for a tire for traveling on unpaved roads. Durability is reduced due to an excessive increase in stiffness when the inclination angle of the reinforcing cords in the carcass layer 4 with respect to the tire radial direction is too high. Among the three layers of the carcass layer 4, the two inside layers of the carcass layer 4 are wound outward from the tire inside around bead cores 5 disposed in the bead portions 3, and an end portion of the one outside layer of the carcass layer 4 is disposed to the outside of the wound portions of the two inside layers of the carcass layer 4. Nylon, polyester, or similar organic fiber cords are preferably used as the reinforcing cords in the carcass layer 4. Further, a bead filler 6 comprising a rubber composition having a cross-sectional triangular shape is disposed on the outer periphery of the bead core 5.

On the other hand, a plurality of layers of a belt layer 7 is embedded on an outer circumferential side of the carcass layer 4 in the tread portion 1. These belt layers 7 include a plurality of reinforcing cords that incline with respect to the tire circumferential direction and the belt layers 7 are disposed so that the reinforcing cords intersect each other between the layers. In the belt layers 7, an inclination angle of the reinforcing cords with respect to the tire circumferential direction is set in a range from, for example, 10° to 40°. Steel cords are preferably used as the reinforcing cords of the belt layers 7.

A belt cover layer 8 of at least one layer and composed of reinforcing cords arranged at an angle of 5° or less with respect to the tire circumferential direction, is disposed on the outer circumferential side of the belt layer 7 in order to improve high-speed durability. The belt cover layer 8 preferably has a jointless structure in which a strip material made from at least one reinforcing cord laid in parallel and covered with rubber is wound continuously in the tire circumferential direction. Also, the belt cover layer 8 can be disposed so as to cover the entire region of the belt layer 7 in the width direction, or can be disposed to cover only the edge portions of the belt layer 7 on the outer side in the width direction. Nylon, aramid, or similar organic fiber cords are preferably used as the reinforcing cords of the belt cover layer 8.

A protective layer 9 including a plurality of organic fiber cords laid in parallel is embedded in the side wall portion 2 on the outer side in the tire axial direction of the carcass layer 4. The upper end portion of the protective layer 9 is disposed near the outer edge position of the belt layer 7, and the lower end portion of the protective layer 9 is disposed on the outer side in the tire axial direction of the bead filler 6. The protective layer 9 contributes to an improvement in cut resistance. While nylon fiber cords, polyester fiber cords, and aramid fiber cords are exemplified as the organic fiber cords used in the protective layer 9, aramid fiber cords which are high-strength and have a superior modulus of elasticity are preferred. The total fiber concentration of the aramid fiber cords may be set to be within a range of 3000 dtex to 4000 dtex. The aramid fiber cords having the above total fiber concentration are preferably used as the reinforcing cords for the above-mentioned protective layer 9. The cord density of the aramid fiber cords that configure the protective layer 9 is preferably from 25 cords/50 mm to 55 cords/50 mm. As a result, the enhancement effect of cut resistance can be sufficiently demonstrated. The angle with respect to the tire radial direction of the organic fiber cords in the protective layer 9 may be set to be within the range of 0° to 60°, or more preferably from 20° to 40°, at the maximum tire width position. While durability decreases due to an increase in the side wall stiffness when the cord angle with respect to the tire radial direction of the protective layer 9 is set excessively high, the reduction in durability can be suppressed by setting the cord angle to be within the above ranges.

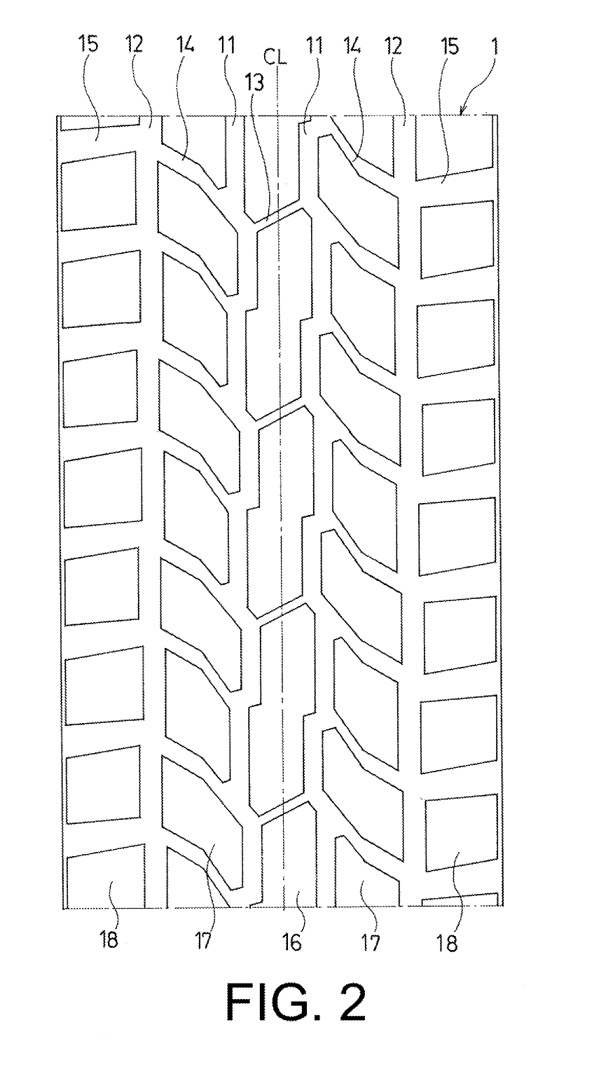

FIG. 2 illustrates a tread pattern of the above-mentioned pneumatic tire. As illustrated in FIG. 2, a plurality of circumferential grooves 11, 12 that extend in the tire circumferential direction, and a plurality of lateral grooves 13, 14, 15 that extend in the tire width direction are formed in the tread portion 1, and a plurality of blocks 16, 17, 18 are partitioned by the circumferential grooves 11, 12 and the lateral grooves 13 to 15. The two circumferential grooves 11 that are positioned on both side of the tire center line CL extend in a zigzag shape in the tire circumferential direction, and the two circumferential grooves 12 positioned on the side of the shoulders extend in a straight line in the tire circumferential direction. The circumferential direction pitch of the lateral grooves 13 that partition the blocks 16 positioned on the tire center line CL is greater than the circumferential direction pitches of the lateral grooves 14, 15 that respectively partition the other blocks 17, 18, or more specifically, the circumferential direction pitch of the lateral grooves 13 is set to be about twice that of the lateral grooves 14, 15. Whereas the lateral grooves 15 that partition the blocks 18 in the shoulder extend substantially parallel to the tire width direction, the inclination angle with respect to the tire circumferential direction of the lateral grooves 14 that partition the intermediate blocks 17 is smaller than the inclination angle with respect to the tire circumferential direction of the lateral grooves 15. While this tread pattern is preferably used in a tire for traveling on unpaved roads, the pneumatic tire according to the present technology is not limited to the tread pattern illustrated in FIG. 2.

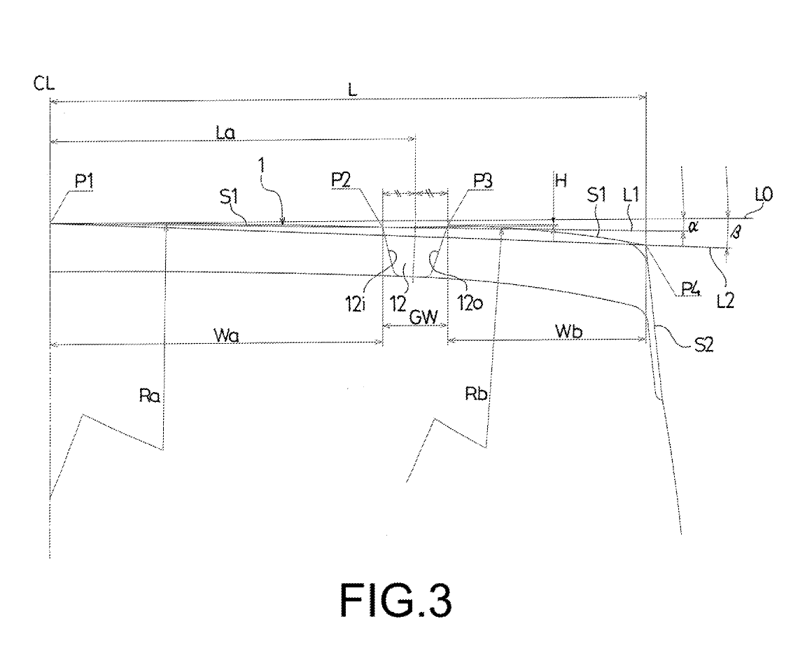

FIG. 3 illustrates a contour of the tread portion 1 in the above-mentioned pneumatic tire. As illustrated in FIG. 3, P1 is an intersection between a road contact surface S1 of the tread portion 1 and the tire center line CL, P2 is an intersection between an inner wall face 12i of the circumferential groove 12 positioned on the outermost side in the tire axial direction and the road contact surface S1 of the tread portion 1, P3 is an intersection between an outer wall face 12o of the outermost circumferential groove 12 and the road contact surface S1 of the tread portion 1, P4 is an outer edge position of the tread portion 1, L0 is a reference straight line that passes through the intersection P1 and extends in the tire axial direction, L1 is a straight line that passes through the intersection P1 and the intersection P2, and L2 is a straight line that passes through the intersection P1 and the outer edge position P4 of the tread portion 1, in the tire meridian cross-section. Note that while the outer edge position P4 of the tread portion 1 is specified due to the edge of the tread portion 1 in the case of a square shoulder, P4 is specified by the position of an intersection between a virtual extended line of the road contact surface S1 of the tread portion 1 and a virtual extended line of the side surface S2 of the tread portion 1.

In the above-mentioned pneumatic tire, the distance La from the tire center line CL to the center position of the outermost circumferential groove 12 has a relationship of 0.50×L≦La≦0.80×L with respect to a tread half-width L from the tire center line to the outer edge position P4 of the tread portion 1. The distance La is an average value on the tire circumference when the position of the outermost circumferential groove 12 changes along the tire circumferential direction (zigzag-shaped circumferential groove, circumferential groove with protruding shapes on the wall face).

An angle β formed by the straight line L2 and the reference straight line L0 has a relationship of 1.2×α≦β≦3.5×α with respect to an angle α formed by the straight line L1 and the reference straight line L0. The angle α formed by the straight line L1 and the reference straight line L0 may be set to be within the range of 0.7° to 2.0°.

Furthermore, the intersection P3 is positioned further to the outside in the tire radial direction than the intersection P2 so that the distance H in the tire radial direction between the intersection P2 and the intersection P3 is set to have the relationship of 0 mm<H≦3 mm. That is, the edge of the land portion (block 18) positioned on the outer side of the outermost circumferential groove 12 protrudes further to the outside in the tire radial direction than the edge of the land portion (block 18) positioned on the inner side of the outermost circumferential groove 12.

In the above-mentioned pneumatic tire having at least one of the circumferential grooves 11, 12 disposed so as to continue in the tire circumferential direction in a region on one side of the tread portion 1, the distance La from the tire center line CL to the center position in the outermost circumferential groove 12 has the relationship of 0.50×L≦La≦0.80×L with respect to the tread half-width L, the angles α and β that define the amount of depression of the tread portion have the relationship of 1.2×α≦β≦3.5×α, and the distance H that defines the amount of protrusion of the land portions positioned on both sides of the outermost circumferential groove 12 has the relationship of 0 mm<H≦3 mm, whereby uneven wear (early wear) of the tread center portion can be avoided since road holding performance of the land portion (block 18) positioned at the tread shoulder portion is enhanced and the load on the tread center portion is reduced. Moreover, side-slipping on muddy or sandy terrain is prevented and steering stability can be improved due to an increase in the connection to the road surface of the land portion (block 18) positioned at the tread shoulder portion whereby the road holding performance thereof is enhanced.

As a result, even when wide circumferential grooves 11, 12 are provided in the tread portion 1 and the side wall stiffness is increased by the addition of the protective layer 9 as in a pneumatic tire for traveling on unpaved roads, road holding performance with the road surface is excellent, uneven wear resistance is enhanced, and steering stability can be improved.

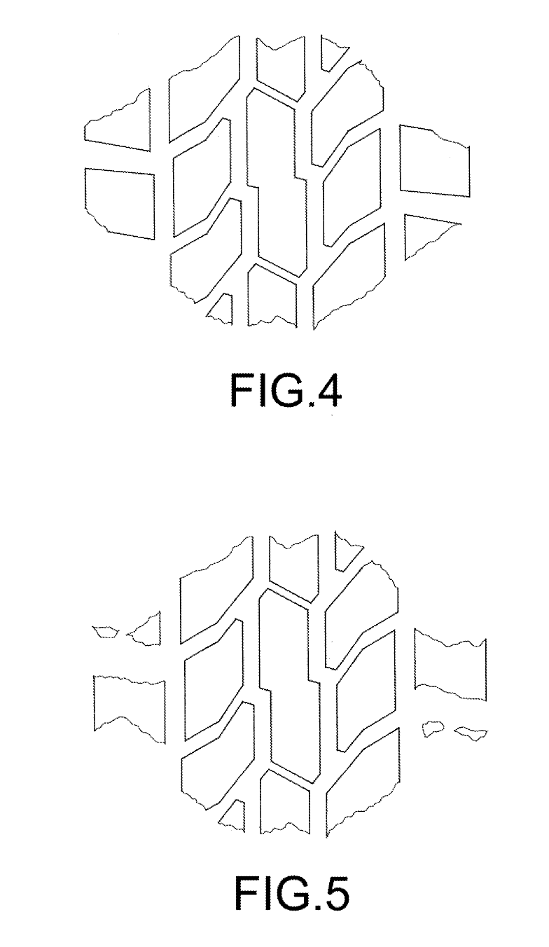

FIG. 4 illustrates a footprint of a pneumatic tire according to the embodiment of the present technology, and FIG. 5 illustrates the footprint of a pneumatic tire having a conventional tread structure. As can be seen when comparing FIG. 4 with FIG. 5, a superior footprint with increased road holding performance in the tread shoulder portion can be formed according to the present technology.

The tread center portion tends to wear easily when the distance La from the tire center line CL to the center position in the outermost circumferential groove 12 has the relationship of La<0.50×L, and conversely the tread shoulder portion tends to become damaged easily when the distance La has the relationship of La>0.80×L. In particular, the distance La preferably satisfies the relationship of 0.55×L≦La≦0.70×L.

When the angle β formed by the straight line L2 and the reference straight line L0 has the relationship of 0<1.2×a, durability is reduced due to the excessive increase of the ground contact pressure in the tread shoulder portion, and conversely, when the angle β has the relationship of β>3.5×α, the expected effects cannot be achieved since the ground contact pressure of the tread shoulder portion is decreased. In particular, the angle β preferably satisfies the relationship of 1.4×α≦β≦2.5×α.

Moreover, when the intersection P3 is disposed further to the inside in the tire radial direction than the intersection P2, the desired effects cannot be achieved since the ground contact pressure of the tread shoulder portion is reduced. When the distance H in the tire radial direction between the intersection P2 and the intersection P3 has the relationship of H>3 mm, the footprint deteriorates and steering stability is reduced. In particular, the distance H preferably satisfies the relationship of 0.3 mm<H≦1.8 mm.

The groove width GW of each of the circumferential grooves 11, 12 disposed in the tread portion 1 in the above-mentioned pneumatic tire is preferably set to be within a range of 8 mm to 20 mm. By forming wide circumferential grooves 11, 12 in this way, the discharge of mud and sands from the circumferential grooves 11, 12 can be improved while the enhancement effects of uneven wear resistance and steering stability are achieved. The discharge of mud and sands is reduced if the groove width GW is less than 8 mm, and conversely, the tread portion 1 may bend more easily if the groove width GW is greater than 20 mm. In particular, the groove width GW is preferably set to be within a range of 12 mm to 18 mm.

Moreover, in the above-mentioned pneumatic tire, the curvature radius Rb of an arc that defines a contour of a region expressed by a width Wb to the outside of the intersection P3 of the tread portion 1 is preferably set to have the relationship of 0.05×Ra≦Rb≦0.3×Ra with respect to the curvature radius Ra of an arc that defines a contour of a region expressed by a width Wa from the intersection P1 to the intersection P2 of the tread portion. As a result, the tread portion forms a desirable footprint and uneven wear resistance is further improved. If the curvature radius Rb has the relationship of Rb<0.05×Ra, the desired effects cannot be achieved since the ground contact pressure of the tread shoulder portion is reduced, and conversely the tread center portion tends to wear easily if the curvature radius Rb has the relationship of Rb>0.3×Ra. In particular, the curvature radius Rb preferably satisfies the relationship of 0.1×Ra≦Rb≦0.2×Ra.

While the carcass layer is described as a multi-layer structure and the carcass layers are disposed so that the reinforcing cords intersect between the layers in the pneumatic tire of the above-mentioned embodiment, this type of carcass structure has a high stiffness and is useful for traveling on unpaved roads and for competitions such as races. However, the present technology may be applied not only to pneumatic tires having the bias structure as described above, but can also be applied to pneumatic tires having a radial structure that has a single layer structure in the carcass layer where the carcass layer is disposed so that the reinforcing cords extend in the tire radial direction. In either case, the pneumatic tire is preferably used for traveling on unpaved roads or for competition. A tire for competition normally is set to have an outer diameter within a range of 32 to 42 inches.

In the case of a tire for traveling on unpaved roads, the groove area ratio of the tread portion 1 may be set to be within the range of 25% to 55%. By selecting this type of groove area ratio, traveling performance on unpaved roads can be sufficiently demonstrated. When the groove area ratio of the tread portion 1 is less than 25%, the traveling performance on muddy or sandy terrain is insufficient, and when the groove area ratio exceeds 55%, the stiffness of the tread portion 1 is reduced and traction in rocky locations is insufficient or defects such as missing blocks may occur more easily.

### EXAMPLES

Tires of a Conventional Example 1, Working Examples 1 to 6, and Comparative Examples 1 to 4 were manufactured, and the dimension requirements defined in FIG. 3 including La/L as the ratio between the distance La from the tire center line to the center position in the outermost circumferential groove and the tread half-width L, β/α as the ratio between the angle α and the angle β, the distance H in the tire radial direction between the intersection P2 and the intersection P3, the land portion width Wb in the shoulder portion, the groove width GW of the outermost circumferential groove, and Ra/Rb as the ratio between the curvature radius Ra and the curvature radius Rb, were set as indicated in Table 1 in pneumatic tires having a tire size of 40×13.50R17, three carcass layers mounted between a pair of bead portions, two belt layers disposed on the outer circumferential side of the carcass layers in the tread portion, and two belt cover layers disposed on the outer circumferential side of the belt layers, two circumferential grooves being disposed so as to continue in the tire circumferential direction in the tread portion in regions on both sides of the tire center line, and a protective layer including organic fiber cords disposed on the outside of the carcass layers in the side wall portion.

The distance H as a positive value signifies that the intersection P3 is positioned further to the outside than the intersection P2 in the tire radial direction, and as a negative value signifies that the intersection P2 is positioned further to the outside than the intersection P3 in the tire radial direction.

The tires used in the testing included 66-nylon fiber cords (1400 dtex/2) arranged at a cord density of 55 cords/50 mm in the carcass layers, steel cords (2+2×0.25 mm) arranged at a cord density of 40 cords/50 mm in the belt layers, and 66-nylon fiber cords (940 dtex/2) arranged at a cord density of 50 cords/50 mm in the belt cover layers. Aramid fiber cords (1670 dtex/2) arranged at a cord density of 30 cords/50 mm were used in the protective layer. The groove area ratio of the tread portion was 37%.

The test tires were evaluated according to the following evaluation methods for uneven wear resistance, steering stability, and travel time, and the results are shown in Table 1.

Uneven wear resistance:

The test tires were assembled on wheels with a rim size of 17×11JJ and mounted on a racing pick-up truck for off-road racing (rear-wheel drive), and driven with the air pressure set to 180 kPa for 160 km by a test driver on an off-road (unpaved road) test course and on a mountainous course (mountain road scattered with rocks and sharp stones) adopted for testing. After the testing, the amount of wear in the tread center portion to the inside of the outermost circumferential groove was measured. The evaluation results were expressed using the multiplicative inverse, indexed with the Conventional Example 1 being 100. Larger index values indicate superior uneven wear resistance.

Steering Stability:

Steering stability was evaluated by sensory evaluation by the test driver during the above travel testing. The evaluation results are expressed as a score from 1 to 5. A higher evaluation score signifies better steering stability.

Travel Time:

The test tires were assembled on wheels with a rim size of 17×11JJ and mounted on a racing pick-up truck for off-road racing (rear-wheel drive), and driven with the air pressure set to 180 kPa by a test driver for one circuit of a 16-km off-road (unpaved road) test course and the travel time was measured. Evaluation results were expressed as index values, Conventional Example 1 being assigned an index value of 100. A smaller index value signifies a shorter travel time.

TABLE 1

| | Conventional | Working | Working | Working | Working | Working |
|---|---|---|---|---|---|---|
| | Example | Example | Example | Example | Example | Example |
| | 1 | 1 | 2 | 3 | 4 | 5 |
| Ratio La/L | 0.59 | 0.61 | 0.50 | 0.80 | 0.55 | 0.55 |
| Ratio β/α | 3.5 | 2.2 | 1.2 | 1.8 | 1.4 | 2.5 |
| Distance H | −0.7 | 0.4 | 0.3 | 1.8 | 3.0 | 0.4 |
| (mm) | | | | | | |
| Land portion | 67 | 60 | 60 | 40 | 75 | 55 |
| width Wb (mm) | | | | | | |
| at shoulder | | | | | | |
| portion | | | | | | |
| Groove width | 15.5 | 15.9 | 15.9 | 12.0 | 18.0 | 20.0 |
| GW (mm) of | | | | | | |
| outermost | | | | | | |
| circumferential | | | | | | |
| groove | | | | | | |
| Ratio Rb/Ra | 0.16 | 0.15 | 0.15 | 0.05 | 0.30 | 0.20 |
| Uneven wear | 100 | 135 | 130 | 125 | 132 | 130 |
| resistance | | | | | | |
| (index) | | | | | | |
| Steering | 2 | 5 | 3 | 4 | 4 | 4 |
| stability (1 to 5) | | | | | | |
| Travel time | 100 | 91 | 97 | 96 | 92 | 95 |
| (index) | | | | | | |

| | | Compar- | Compar- | Compar- | Compar- |
|---|---|---|---|---|---|
| | Working | ative | ative | ative | ative |
| | Example | Example | Example | Example | Example |
| | 6 | 1 | 2 | 3 | 4 |
| Ratio La/L | 0.70 | 0.45 | 0.70 | 0.85 | 0.50 |
| Ratio β/α | 3.5 | 1.0 | 3.8 | 3.0 | 30.0 |
| Distance H | 0.4 | 0 | 3.5 | 3.5 | 2.5 |
| (mm) | | | | | |
| Land portion | 40 | 60 | 35 | 40 | 80 |
| width Wb (mm) | | | | | |
| at shoulder | | | | | |
| portion | | | | | |
| Groove width | 8.0 | 22.0 | 6.0 | 15.0 | 20.0 |
| GW (mm) of | | | | | |
| outermost | | | | | |
| circumferential | | | | | |
| groove | | | | | |
| Ratio Rb/Ra | 0.25 | 0.03 | 0.35 | 0.15 | 0.20 |
| Uneven wear | 127 | 101 | 103 | 104 | 104 |
| resistance | | | | | |
| (index) | | | | | |
| Steering | 3 | 3 | 2 | 2 | 2 |
| stability (1 to 5) | | | | | |
| Travel time | 96 | 98 | 99 | 100 | 98 |
| (index) | | | | | |

As can be seen in Table 1, the tires of Working Examples 1 to 6 demonstrated superior uneven wear resistance, superior steering stability, and shorter travel times when compared with Conventional Example 1. Conversely, the tires of Comparative Examples 1 to 4 demonstrated less enhancement effects in comparison to Working Examples 1 to 6 since the tread structure was not suitable.

1. A pneumatic tire, comprising:
a tread portion extending in a tire circumferential direction to form an annular shape;
a pair of side wall portions that is disposed on both sides of the tread portion;
a pair of bead portions that is disposed on an inner side in a tire radial direction of the side wall portions;
at least one carcass layer being mounted between the pair of bead portions;
a plurality of belts layers being disposed on outer circumferential sides of the carcass layer at the tread portion; and
at least one circumferential groove being disposed in the tread portion so as to continue in the tire circumferential direction in a region on one side of a tire center,
wherein:
in a tire meridian cross-section, P1 is an intersection between a road contact surface of the tread portion and a tire center line; P2 is an intersection between an inner wall surface of a circumferential groove positioned on an outmost side in a tire axial direction and the road contact surface of the tread portion; P3 is an intersection between an outer wall surface of the outermost circumferential groove and the road contact surface of the tread portion; P4 is an outer edge position of the tread portion; L0 is a reference straight line that extends in the tire radial direction from the intersection P1; L1 is a straight line that passes through the intersection P1 and the intersection P2; and L2 is a straight line that passes through the intersection P1 and the outer edge position P4 of the tread portion;
a distance La from the tire center line to a center position of the outermost circumferential groove has a relationship of 0.50×L≦La≦0.80×L with respect to a tread half-width L from the tire center line to the outer edge position P4 of the tread portion;
an angle β formed by the straight line L2 and the reference straight line L0 has a relationship of 1.2×α≦β≦3.5×α with respect to an angle α formed by the straight line L1 and the reference straight line L0; and
the intersection P3 is disposed on an outer side in the tire radial direction of the intersection P2 so that a distance H in the tire radial direction between the intersection P2 and the intersection P3 has a relationship of 0 mm<H≦3 mm.

2. The pneumatic tire according to claim 1, wherein a groove width GW of each of the circumferential grooves disposed in the tread portion is set to be within a range of 8 mm to 20 mm.

3. The pneumatic tire according to claim 2, wherein a curvature radius Rb of an arc that defines a contour of a region Wb to an outer side of the intersection P3 of the tread portion has a relationship of 0.05×Ra≦Rb≦0.3×Ra with respect to a curvature radius Ra of an arc that defines a contour of a region Wa from the intersection P1 to the intersection P2 of the tread portion.

4. The pneumatic tire according to claim 3, wherein a groove area ratio of the tread portion is from 25% to 55%, and the pneumatic tire is a tire for traveling on unpaved roads.

5. The pneumatic tire according to claim 4, wherein a protective layer including organic fiber cords is disposed on an outer side of the carcass layer in the side wall portion.

6. The pneumatic tire according to claim 3, wherein a protective layer including organic fiber cords is disposed on an outer side of the carcass layer in the side wall portion.

7. The pneumatic tire according to claim 2, wherein a protective layer including organic fiber cords is disposed on an outer side of the carcass layer in the side wall portion.

8. The pneumatic tire according to claim 2, wherein a groove area ratio of the tread portion is from 25% to 55%, and the pneumatic tire is a tire for traveling on unpaved roads.

9. The pneumatic tire according to claim 1, wherein a curvature radius Rb of an arc that defines a contour of a region Wb to an outer side of the intersection P3 of the tread portion has a relationship of 0.05×Ra≦Rb≦0.3×Ra with respect to a curvature radius Ra of an arc that defines a contour of a region Wa from the intersection P1 to the intersection P2 of the tread portion.

10. The pneumatic tire according to claim 1, wherein a groove area ratio of the tread portion is from 25% to 55%, and the pneumatic tire is a tire for traveling on unpaved roads.

11. The pneumatic tire according to claim 1, wherein a protective layer including organic fiber cords is disposed on an outer side of the carcass layer in the side wall portion.

12. The pneumatic tire according to claim 1, wherein a curvature radius Rb of an arc that defines a contour of a region Wb to an outer side of the intersection P3 of the tread portion has a relationship of 0.1×Ra≦Rb≦0.2×Ra with respect to a curvature radius Ra of an arc that defines a contour of a region Wa from the intersection P1 to the intersection P2 of the tread portion.

13. The pneumatic tire according to claim 1, wherein the pneumatic tire has an outer diameter within a range of 32 to 42 inches.

14. The pneumatic tire according to claim 1, wherein a groove width GW of each of the circumferential grooves disposed in the tread portion is set to be within a range of 12 mm to 18 mm.

15. The pneumatic tire according to claim 1, wherein the intersection P3 is disposed on an outer side in the tire radial direction of the intersection P2 so that the distance H in the tire radial direction between the intersection P2 and the intersection P3 has a relationship of 0.3 mm<H≦1.8 mm.

16. The pneumatic tire according to claim 1, wherein the angle β formed by the straight line L2 and the reference straight line L0 has a relationship of 1.4×α≦β≦2.5×α with respect to the angle α formed by the straight line L1 and the reference straight line L0.

17. The pneumatic tire according to claim 1, wherein the distance La from the tire center line to the center position of the outermost circumferential groove has a relationship of 0.55×L≦La≦0.70×L with respect to the tread half-width L from the tire center line to the outer edge position P4 of the tread portion.

18. The pneumatic tire according to claim 1, wherein the plurality of belt layers comprise steel reinforcing cords, the pneumatic tire further comprising a belt cover layer comprising a jointless structure in which a strip material made from at least one reinforcing cord laid in parallel and covered with rubber is wound continuously in the tire circumferential direction, wherein the belt cover layer is disposed so as to cover an entire region of the plurality of belt layers in a width direction.

19. The pneumatic tire according to claim 1, wherein the plurality of belt layers comprise steel reinforcing cords, the pneumatic tire further comprising a belt cover layer comprising a jointless structure in which a strip material made from at least one reinforcing cord laid in parallel and covered with rubber is wound continuously in the tire circumferential direction, wherein the belt cover layer is disposed so to cover only edge portions of the plurality of belt layers on an outer side in a width direction.

20. The pneumatic tire according to claim 1, further comprising a belt cover layer disposed so as to cover at least a portion of the plurality of belt layers, the belt cover layer comprising an aramid fiber cord having a fiber concentration within a range of 3000 dtex to 4000 dtex, a cord density of 25 cords/50 mm to 55 cords/50 mm, and an angle with respect to the tire radial direction within a range of from 20° to 40°.
